(19) United States
(12) Patent Application Publication
(10) Pub. No.: US 2017/0243187 A1
(43) Pub. Date: Aug. 24, 2017

(54) FUEL DISPENSING SYSTEM

(71) Applicant: EXXONMOBIL RESEARCH ENGINEERING COMPANY, Annandale, NJ (US)

(72) Inventors: Chee Lip LIN, (SG); Geraldine Ai Lin CHIN, (SG)

(21) Appl. No.: 15/510,706

(22) PCT Filed: Sep. 17, 2015
(86) PCT No.: PCT/US2015/050558

§ 371 Date: Mar. 13, 2017

(30) Foreign Application Priority Data
Sep. 17, 2014 (SG) 1020145800Q

(51) Int. Cl. G06Q 20/18; G06Q 20/32

(52) U.S. Cl. CPC G06Q 20/18; G06Q 20/3278

(57) ABSTRACT

The present disclosure provides a fuel dispensing system. The fuel dispensing system includes: (1) an on-board unit reader programmed to identify vehicle information stored in the on-board unit, (2) an electronic point-of-sales system programmed to control at least one fueling dispenser and compute payment value, (3) a front end processor programmed to communicate with the electronic point-of-sales system. The system may further comprise a financial processing computer network programmed to communicate with the front end processor. The system may be used in supporting prepaid card, credit card, or debit card transactions.

### FIELD OF THE INVENTION

The present disclosure relates to fuel dispensing systems to purchase and dispense fuel from a dispensing site having an electronic point-of-sales system.

### BACKGROUND OF THE INVENTION

This section provides background information relating to the present disclosure which is not necessarily prior art.

Presently, payment of fueling at dispensing sites can be done either indoor or outdoor. Outdoor payment has become a trend which could reduce queuing time for users. In order to improve experience of users, a lot of efforts have been made in recent years.

Many fuel dispensing sites have multiple fuel dispensers, each of which are equipped with a credit card reader that can communicate with an electronic point-of-sales system in the fuel dispensing site. The electronic point-of-sales system, in turn, seeks verification and authorization for each payment.

However, it is not convenient for users to take or use credit cards in many circumstances. The users still need to carry a credit card for verification to refuel vehicles. The users have to worry about misplacing or not having their credit cards with them. For company users that own a fleet of vehicles, credit cards have to be issued to each vehicle. The credit cards run a risk of being abused to pay for fueling of other unauthorized vehicles. There is minimal verification or limited to manual verification that the credit cards are used for the intended vehicles. When there is a change in the fleet of vehicles, it could take several days to receive new credit cards.

It is reported that many vehicles have mounted on-board units, for example it is mandatory to install in-vehicle units in Singapore, which include radio communication means in order to solve traffic jam by electronically imposing fees when the vehicle is going into such area. U.S. Pat. No. 5,774,795 discloses use of the in-vehicle unit disposed on the windshield glass of an automobile in toll collection system for a toll road.

Now, there is a need on how to use the on-board unit mounted on a vehicle to purchase and dispense fuel in fuel dispensing sites.

### SUMMARY OF THE INVENTION

This section provides a general summary of the disclosure, and is not a comprehensive disclosure of its full scope or all of its features.

The present disclosure provides fuel dispensing systems to facilitate use of on-board unit mounted on a vehicle to purchase and dispense fuel from a dispensing site having an electronic point-of-sales system. The fuel dispensing system described here allows the vehicle to be identified upon positioning next to a fuel dispenser. After the vehicle information is verified, the user simply lifts the pump handle, inserts the nozzle into the filler neck and squeezes the nozzle handle to commence fueling. It is not necessary for the user to produce a card for each payment since payment account information of the card is linked to the vehicle information stored in an on-board unit mounted on the vehicle during a one-time sign up process. The transaction will be charged to their authorized payment cards.

The present disclosure meets a need of those users who rank convenience and efficiency highly during the course of fueling.

### BRIEF DESCRIPTION OF THE DRAWINGS

The drawings described herein are for illustrative purpose only of selected embodiments and not all possible implementations, and are not intended to limit the scope of the present disclosure.

FIG. 1 is a system block diagram of the fuel dispensing system in accordance with the present disclosure;

FIG. 2 depicts exemplary the on-board unit mounted on a vehicle;

FIG. 3 illustrates an embodiment how to activate an on-board unit reader and transfer vehicle information to the electronic point-of-sales system;

FIG. 4 is an example of a sequence diagram illustrating how messages are communicated among the fuel dispenser, electronic point-of-sales system and front end processor in the fuel dispensing system;

FIG. 5 is an example of a sequence diagram illustrating how messages are communicated among the fuel dispenser, electronic point-of-sales system, front end processor and financial processing computer network in the fuel dispensing system.

### DETAILED DESCRIPTION OF THE EMBODIMENTS

Exemplary embodiments will now be described more fully with reference to the accompanying drawings.

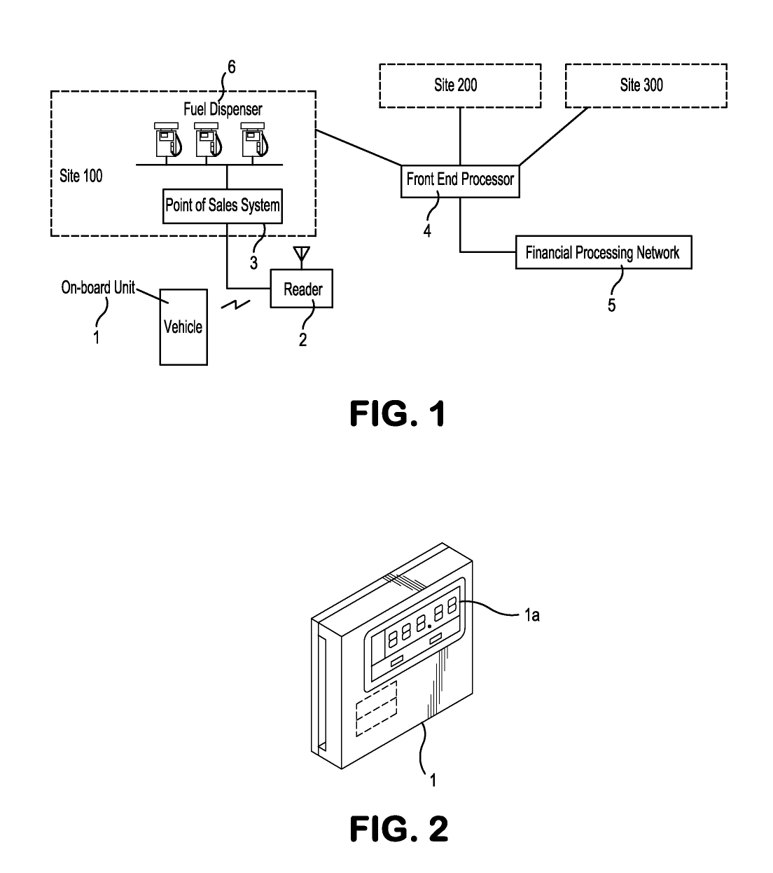

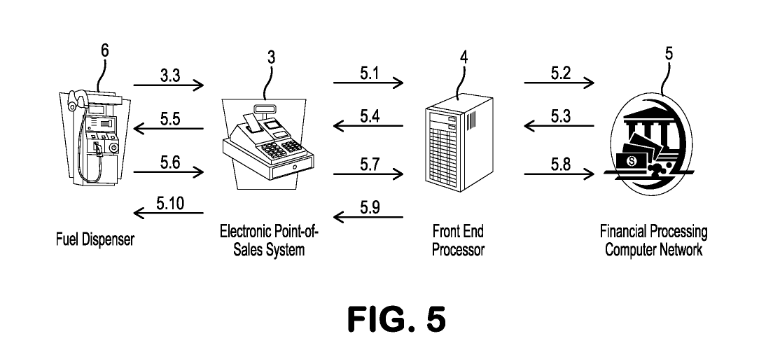

A fuel dispensing system in accordance with the present disclosure is illustrated by reference to FIG. 1. The system facilitates use of an on-board unit 1 mounted on a vehicle to purchase and dispense fuel from a dispensing site (exemplary dispensing site 100 having been illustrated). The fuel dispensing system comprises: an on-board unit reader 2 programmed to identify vehicle information from the on-board unit 1; an electronic point-of-sales system 3 programmed to control at least one fueling dispenser 6 and compute payment value; a front end processor 4 programmed to communicate with the electronic point-of-sales system 3; wherein, the on-board unit reader being programmed to communicate with the electronic point-of-sales system 3 for transferring the vehicle information; the front end processor 4 being programmed to verify linkage between the vehicle information and payment account information stored in the front end processor 4 before sending authorization of fueling; the front end processor 4 being further programmed to communicate with the electronic point-of-sales system 3 for charging. As a separated embodiment, the system may further comprise a financial processing computer network 5 programmed to communicate with the front end processor 4, which is described in detail in FIG. 5.

FIG. 2 is an example of the on-board unit 1 including a liquid crystal display la mounted on the front surface thereof. The on-board unit 1 stores particular vehicle information such as, for example, an on-board unit code, an on-board unit type, a manufacturing date and the like, and includes radio communication means. The term “on-board unit” as used herein, means any vehicle identification unit mounted on a vehicle includes but not limited to in-vehicle unit and identity card. In a preferred embodiment, the on-board unit may be in-vehicle unit.

On-board unit 1 can include an active on-board part with an oscillator for radio frequency (RF) wave, and a passive on-board part without an oscillator for RF wave. The passive on-board part reflects and modulates an RF wave transited from the on-board unit reader located in at least one fuel dispenser, and transmits or returns the reflected and modulated RF wave to the on-board unit reader as an uplink RF wave.

The on-board unit reader 2 can be equipped with an antenna, and the communication between antenna and the on-board unit 1 is carried out by an RF wave in the quasi-microwave band.

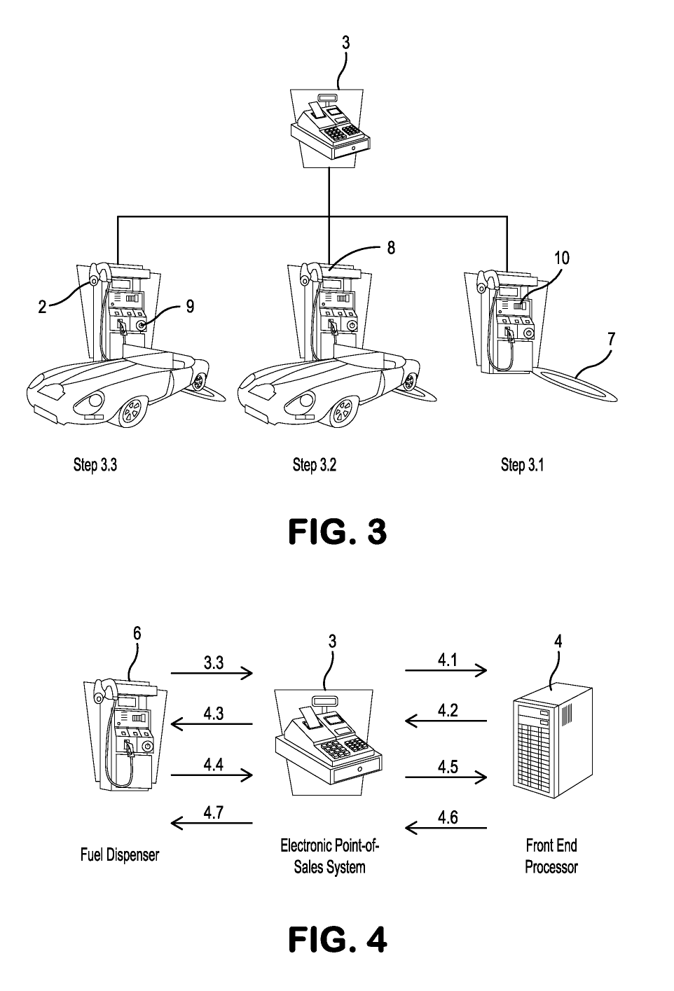

FIG. 3 illustrates an embodiment how to activate the on-board unit reader 2 and transfer vehicle information to the electronic point-of-sales system 3.

When a fuel dispenser 6 is available for users, the on-board unit reader 2 is on standby and the status button 9 installed on it displays a first color, such as blue, as Step 3.1. If a vehicle is positioned next to the fuel dispenser 6, a triggering apparatus 7 may activate the on-board unit reader 2 to read the vehicle information from the on-board unit 1 and store the vehicle information including time and date stamp at an acceptance apparatus 8 mounted on the on-board unit reader 2. After activation, the status button 9 on the on-board unit reader turns a second color, such as green, as Step 3.2. The triggering apparatus can correspond to any convenient type of apparatus for detecting the presence of a vehicle. This can include, but is not limited to, optical detection of a vehicle as shown in FIG. 3, or detection of a signal from the on-board unit mounted on the vehicle.

When the user presses the status button 9 on the on-board unit to confirm their intention to fuel the vehicle, the status button turns a third color, such as red, as shown in Step 3.3. The vehicle information obtained by the on-board unit reader 2 will be transferred to the electronic point-of-sales system 3 from the acceptance apparatus 8.

FIG. 4 is an example illustrating how messages are communicated among the fuel dispenser, electronic point-of-sales system and front end processor of the fuel dispensing system.

At Step 4.1 the electronic point-of-sales system 3 formats and sends verification request to the front end processor 4. The request may include the identity of dispensing site and fuel dispenser, time and date stamp, and the vehicle information. The vehicle information is cross-referenced to payment account information stored in the front end processor 4. The front end processor 4 has associated memory that stores an operating system, such as UNIX operating system. Of course other operating system platforms may be used instead. While waiting for the verification to be processed, the electronic point-of-sales system 3 will suspend any request from the fuel dispenser 6.

At Step 4.2 and 4.3 if the linkage between the vehicle information and payment account information is verified, the front end processor 4 may send an authorization response to the electronic point-of-sales system 3 to instruct it to proceed to authorize the fuel dispenser 6 for fueling. The term “linkage” as used herein, means whether the identified vehicle information is consistent with the payment account information which is prior provided by users through sign up system.

If the verification process in Step 4.1 fails, the electronic point-of-sales system 3 may send a message to the fuel dispenser 6 to inform the user to proceed with other form of payment, and a notice can be shown on the screen of the fuel dispenser 6.

At Step 4.4 and 4.5 when the fueling is completed, the fuel dispenser 6 delivers actual fueling information including fueling volume, to the electronic point-of-sales system 3. The electronic point-of-sales system 3 computes payment value, assembles the actual fueling information with payment information and sends them to the front end processor 4. The front end processor 4 retrieves the authorization data at Step 4.1 and combines the payment information and the authorization data for charging the user.

At Step 4.6 and 4.7 the front end processor may send a fueling completion message to the electronic point-of-sales system 3. The receipt information of the payment is then sent to the fuel dispenser 6 for printing.

The present disclosure further provides a use for the fuel dispensing system in this above embodiment in supporting pre-paid card transactions. The term “pre-card” may include those cards are issued by individuals or entities which manage or own the dispensing sites.

In another embodiment, the fuel dispensing system may further comprise a financial processing computer network 5 programmed to communicate with the front end processor 4. Thus, the fuel dispensing system to facilitate use of an on-board unit 1 mounted on a vehicle to purchase and dispense fuel from a dispensing site, comprising: an on-board unit reader 2 programmed to identify vehicle information stored in the on-board unit 1; an electronic point-of-sales system 3 programmed to control at least one fueling dispenser 6 and compute payment value; a front end processor 4 programmed to communicate with the electronic point-of-sales system 3; a financial processing computer network 5 programmed to communicate with the front end processor 4; wherein, the on-board unit reader 2 being programmed to communicate with the electronic point-of-sales system 3 for transferring the vehicle information; the front end processor 4 being programmed to verify linkage between the vehicle information and payment account information stored in the front end processor 4 before sending authorization of fueling; the financial processing computer network 5 being programmed to send authorization to the front end processor 4; the financial processing computer network 5 being further programmed to communicate with the front end processor 4 for charging. The term “financial processing computer network” as used herein, refers to a network system which is managed by banks. The payment cards which are suitable for this embodiment include those cards issued by banks, such as credit cards and debit cards.

FIG. 5 further illustrates how messages are communicated among fuel dispenser, electronic point-of-sales system, front end processor and financial processing computer network of the fuel dispensing system.

At Step 5.1 the electronic point-of-sales system 3 formats and sends verification request to the front end processor 4. The request may include identity of the dispensing site and fuel dispenser, time and date stamp, and the vehicle information. While waiting for the verification to be processed, the electronic point-of-sales system 3 can suspend any request from the fuel dispenser 6.

At Step 5.2 the vehicle information is cross-referenced to the payment account information stored in the front end processor 4. If the linkage between the vehicle information and payment account information is verified, the payment account information is then streamed into the verification request and sent to the financial processing computer network 5 for authorization.

If the verification process in Step 5.1 and 5.2 fails, the electronic point-of-sales system 3 will send a message to the fuel dispenser 6 to inform the user to proceed with other form of payment, and a notice will be shown on the screen of the fuel dispenser 6.

At Step 5.3 when the financial process computer network 5 returns with an authorization, the front end processor 4 may hold the authorization information until the electronic point-of-sales system 3 returns with actual fueling information.

At Step 5.4 and 5.5 the front end processor 4 will send an authorization response to the electronic point-of-sales system 3 to instruct it to proceed to authorize the fuel dispenser 6 for fueling.

At Step 5.6 and 5.7 when the fueling is completed, the fuel dispenser 6 delivers the actual fueling information to the electronic point-of-sales system 3. The electronic point-of-sales system 3 computes the payment value, assembles the actual fueling information with payment information and sends them to the front end processor 4.

At Step 5.8 the front end processor 4 retrieves the authorization data at Step 5.3, combines it with the payment information, and then send all the information to the financial process computer network 5 for charging the user.

At Step 5.9 and 5.10 the front end processor 4 may send a fueling completion message to the electronic point-of-sales system 3. The receipt information of the payment is then sent to the fuel dispenser 6 for printing.

The present disclosure further provides a use for the fuel dispensing system in this above embodiment in supporting credit card or debit card transactions. The terms “credit card” or “debit card” may include those cards are issued by banks.

In the present disclosure, users do not need to produce payment cards at each payment except during one-time sign up process. In a preferred embodiment, the fuel dispensing system may further comprise a sign up system. Each User may complete the sign up process by providing their vehicle information and payment card information in a paper form for manually inputting into the sign up system. The vehicle information and payment card information will be stored in the front end processor 4 as payment account information. In a more preferred embodiment, the user can sign up through a sign up server and all the information will be validated by a sign up server and transfer to the front end processor.

The sign up server could be registered by entering into a webpage. If the user successfully registered his or her email address and password, the website then presents a “create account” screen. At this screen the user provides basic personal information. Next, the user is required to enter payment card information and vehicle information. Finally, once the account has been created, the user is given a confirmation screen.

In another alternative embodiment, for company users with a fleet of vehicles, they could provide a list of vehicle information on an electronica spreadsheet. The information on the spreadsheet will be transferred to the sign up server. Such users will also be given a user identity and password which will allow them ongoing update for the list of vehicles online via the sign up server.

The foregoing description of the embodiments has been provided for purpose of illustration and description. It is not intended to be exhaustive or to limit the disclosure. Individual elements or features of a particular embodiment are generally not limited to that particular embodiment, abut, where applicable, are interchangeable and can be used in a selected embodiment, even if not specifically shown or described. The same may also be varied in many ways. Such variation is not to be regarded as a departure from the disclosure, and all such modifications are intended to be included within the scope of the disclosure.

1. A fuel dispensing system to facilitate use of an on-board unit (1) mounted on a vehicle to purchase and dispense fuel from a dispensing site, the system comprising:
i. an on-board unit reader (2) programmed to identify vehicle information stored in said on-board unit (1);
ii. an electronic point-of-sales system (3) programmed to control at least one fueling dispenser (6) and compute payment value; and
iii. a front end processor (4) programmed to communicate with said electronic point-of-sales system (3),
wherein, said on-board unit reader (2) being programmed to communicate with said electronic point-of-sales system (3) for transferring said vehicle information; said front end processor (4) being programmed to verify linkage between said vehicle information and payment account information stored in said front end processor (4) before sending authorization of fueling; said front end processor (4) being further programmed to communicate with said electronic point-of-sales system (3) for charging.

2. A fuel dispensing system to facilitate use of a vehicle-mounted on-board unit (1) to purchase and dispense fuel from a dispensing site, the system comprising:
i. a dispensing site on-board unit reader (2) programmed to identify vehicle information stored in a vehicle-mounted on-board unit (1);
ii. an electronic point-of-sales system (3) programmed to control at least one fueling dispenser (6) and compute payment value;
iii. a front end processor (4) programmed to communicate with the electronic point-of-sales system (3); and
iv. a trigger apparatus to detect a presence of a vehicle and to activate the dispensing site on-board unit reader (2),
wherein the dispensing site on-board unit reader (2) is programmed to communicate with the electronic point-of-sales system (3) for transferring the identified vehicle information; wherein the front end processor (4) is programmed to verify linkage between the identified vehicle information and payment account information stored in said front end processor (4) before sending authorization of fueling; and wherein the front end processor (4) is further programmed to communicate with said electronic point-of-sales system (3) for charging.

3. The fuel dispensing system of claim 1, wherein said on-board unit (1) is an in-vehicle unit.

4. The fuel dispensing system of claim 1, wherein said on-board unit (1) is an identity card.

5. The fuel dispensing system of claim 1, further comprising a triggering apparatus (7) programmed to activate said on-board unit reader (2).

6. The fuel dispensing system of claim 1, further comprising an acceptance apparatus (8) to transfer said vehicle information of on-board unit to said electronic point-of-sales system (3).

7. The fuel dispensing system of claim 1, wherein said front end processor (4) is further programmed to interface with a sign up system.

8. The fuel dispensing system of claim 7, wherein said sign up system is a sign up server.

9. A use for the fuel dispensing system of claim 1 in supporting pre-paid card transactions.

10. A fuel dispensing system to facilitate use of an on-board unit (1) mounted on a vehicle to purchase and dispense fuel from a dispensing site, the system comprising:
i. an on-board unit reader (2) programmed to identify vehicle information stored in said on-board unit (1);
ii. an electronic point-of-sales system (3) programmed to control at least one fueling dispenser (6) and compute payment value;
iii. a front end processor (4) programmed to communicate with said electronic point-of-sales system (3); and
iv. a financial processing computer network (5) programmed to communicate with said front end processor (4), wherein, said on-board unit reader (2) being programmed to communicate with said electronic point-of-sales system (3) for transferring said vehicle information; said front end processor (4) being programmed to verify linkage between said vehicle information and payment account information stored in said front end processor (4) before sending authorization of fueling; said financial processing computer network (5) being programmed to send authorization to said front end processor (4); said financial processing computer network (5) being further programmed to communicate with said front end processor (4) for charging.

11. The fuel dispensing system of claim 10, wherein said on-board unit (1) is an in-vehicle unit.

12. The fuel dispensing system of claim 10, wherein said on-board unit (1) is an identity card.

13. The fuel dispensing system of claim 10, further comprising a triggering apparatus (7) programmed to activate said on-board unit reader (2).

14. The fuel dispensing system of claim 10, further comprising an acceptance apparatus (8) to transfer said vehicle information of on-board unit to said electronic point-of-sales system (3).

15. The fuel dispensing system of claim 10, wherein said front end processor (4) is further programmed to interface with a sign up system.

16. The fuel dispensing system of claim 15, wherein said sign up system is a sign up server.

17. A use for the fuel dispensing system of claim 10 in supporting credit card transactions.

18. A use for the fuel dispensing system of claim 10 in supporting debit card transactions.
